(19) United States
(12) Patent Application Publication
(10) Pub. No.: US 2009/0228254 A1
(43) Pub. Date: Sep. 10, 2009

(54) METHOD OF SIMULATING PNEUMATIC TIRE BASED ON FINITE ELEMENT MODELS

(75) Inventors: Hideki Seto, Hiratsuka (JP); Ryoji Hanada, Hiratsuka (JP)

Correspondence Address: KNOBBE MARTENS OLSON & BEAR LLP, 2040 MAIN STREET, FOURTEENTH FLOOR, IRVINE, CA, 92614, US

(73) Assignee: The Yokohama Rubber Co., Ltd., Tokyo (JP)

(21) Appl. No.: 12/368,905

(22) Filed: Feb. 10, 2009

(30) Foreign Application Priority Data
Feb. 12, 2008 (JP) 2008-030101

(51) Int. Cl. G06G 7/48; G06F 17/50

(52) U.S. Cl. 703/6

(57) ABSTRACT

A pneumatic tire includes a composite assembly comprising a rubber web and a plurality of parallel cords embedded in the rubber web at spaced intervals in the circumferential directions of the pneumatic tire. The pneumatic tire is approximated with a finite element model generated by dividing the pneumatic tire into a plurality of finite elements and analyzing the finite element model according to a finite element process. A composite assembly element model is generated for the composite assembly by dividing the rubber web into rubber web elements as solid models and dividing the cords into cord elements as solid elements, according to the finite element process.

### FIELD OF THE INVENTION

The present invention relates to a method of simulating a pneumatic tire based on finite element models.

### BACKGROUND ART

There have been proposed in the art a variety of methods of simulating a pneumatic tire (also referred to simply as “tire”) by approximating the pneumatic tire with a finite element model which is generated by dividing the tire into a plurality of finite elements and analyzing the finite element model according to the finite element method.

According to one of the proposed pneumatic tire simulating methods, a composite assembly (stiffener) of a belt and a carcass, each including a plurality of cords, among other components of the tire, is converted into a simplified model, rather than a faithful model (see JP No. 11-153520 A). Specifically, the cords are modeled into a quadrilateral membrane element with defined anisotropy, and the composite assembly is calculated as a continuous body whose cross-sectional shape remains the same in the circumferential directions of the tire.

The reasons for the above simulation proposal are as follows: If the cords of the composite assembly are to be converted into a faithful model, then the cords have to be divided into a number of elements. Since the carcass or belt of a single tire includes more than thousand cords, the simulation needs vast computational efforts and hence is highly tedious and time-consuming to carry out. However, the simulating computational efforts and the time required for the simulating process can be greatly reduced if the cords are modeled into simply shaped elements.

The proposed simulating method, however, is disadvantageous in that as the cords of the composite assembly is modeled into a quadrilateral membrane element that is completely different in shape from the actual cords, the quadrilateral membrane element fails to properly analyze the behaviors of the composite assembly. The proposed simulating method thus fails to sufficiently analyze the performance of the tire with accuracy.

### SUMMARY OF THE INVENTION

It is an object of the present invention to provide a method of simulating a pneumatic tire for accurately analyzing the performance of the pneumatic tire based on finite element models.

According to an aspect of the present invention, there is provided a method of simulating a pneumatic tire including a composite assembly comprising a rubber web and a plurality of parallel cords embedded in the rubber web at spaced intervals in the circumferential directions of the pneumatic tire, by approximating the pneumatic tire with a finite element model generated by dividing the pneumatic tire into a plurality of finite elements and analyzing the finite element model according to a finite element process, the method comprising the step of generating a composite assembly element model for the composite assembly by dividing the rubber web into rubber web elements as solid models and dividing the cords into cord elements as solid elements, according to the finite element process.

Since the composite assembly element model for the composite assembly is made up of the rubber web elements as solid models and the cord elements as solid elements, stresses and strains of the composite assembly can be analyzed accurately for an accurate evaluation of the performance of the pneumatic tire.

The above and other objects, features, and advantages of the present invention will become apparent from the following description when taken in conjunction with the accompanying drawings which illustrate a preferred embodiment of the present invention by way of example.

### BRIEF DESCRIPTION OF THE DRAWINGS

FIG. 1 is a transverse cross-sectional view of a pneumatic tire taken along a plane extending through the central axis thereof;

FIG. 2 is an enlarged fragmentary perspective view, partly in cross section, showing structural details of a composite assembly of a carcass and a belt of the pneumatic tire shown in FIG. 1;

FIG. 3 is a plan view of the composite assembly as viewed in the direction of arrow A in FIG. 2;

FIG. 4 is a block diagram of a computer used for carrying out a method of simulating a pneumatic tire according to an embodiment of the present invention;

FIG. 5 is a block diagram of a functional system provided by the computer shown in FIG. 4;

FIG. 6(A) is a schematic cross-sectional view of the composite assembly;

FIG. 6(B) is a schematic cross-sectional view of a finite element model of the composite assembly according to the background art;

FIG. 6(C) is a schematic cross-sectional view of a finite element model of the composite assembly according to the embodiment of the present invention;

FIG. 7 is a partial perspective view of a finite element model of the carcass of the composite assembly according to the embodiment of the present invention;

FIG. 8 is an enlarged perspective view of a portion of the finite element model;

FIG. 9 is a schematic view showing the constraint of nodes of the finite element model of the composite assembly according to the embodiment of the present invention;

FIG. 10 is a flowchart of the sequence of the method of simulating a pneumatic tire according to the embodiment of the present invention;

FIG. 11 is a view showing a distribution of stresses (strains) on a pneumatic tire simulated by a simulating method according to a comparative example; and

FIG. 12 is a view showing a distribution of stresses (strains) on a pneumatic tire simulated by a simulating method according to an inventive example.

### DETAILED DESCRIPTION OF THE INVENTION

A method of simulating a pneumatic tire according to an embodiment of the present invention will be described in detail below with reference to the drawings.

First, a composite assembly (stiffener) of a tire and a process of modeling the composite assembly will be described below.

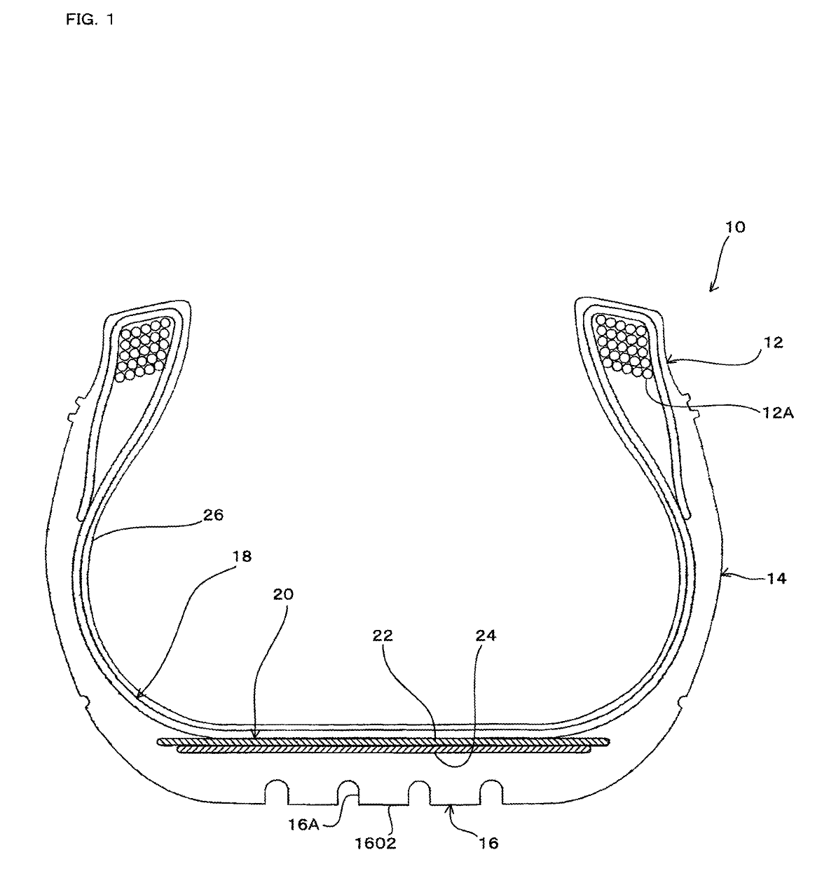

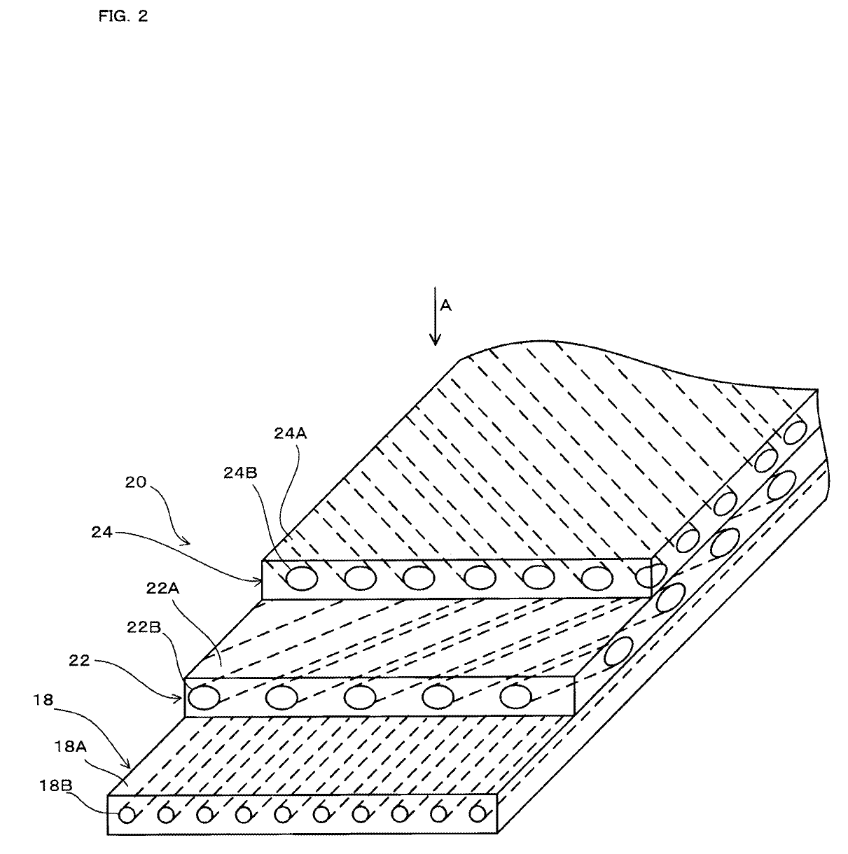

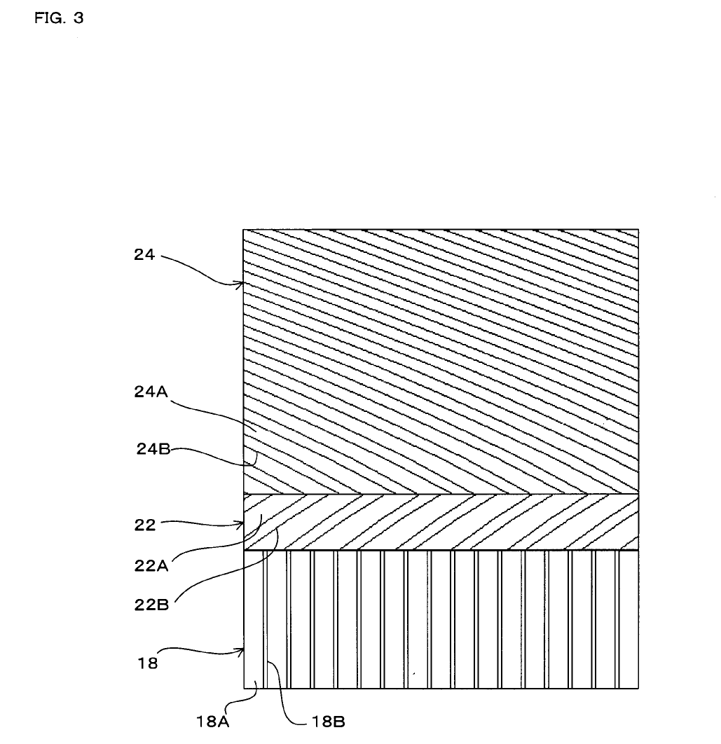

FIG. 1 is a transverse cross-sectional view of a pneumatic tire 10 taken along a plane extending through the central axis thereof. FIG. 2 is an enlarged fragmentary perspective view, partly in cross section, showing structural details of a composite assembly of a carcass and a belt of the pneumatic tire shown in FIG. 1. FIG. 3 is a plan view of the composite assembly as viewed in the direction of arrow A in FIG. 2.

As shown in FIG. 1, the tire 10 comprises a pair of laterally spaced beads 12, a pair of laterally spaced sidewalls 14, a tread 16, a carcass 18, and a belt 20. The carcass 18 and the belt 20 jointly serve as a composite assembly as described later.

The beads 12, which serve to mount the tire 10 on the rim of a wheel, support the opposite ends of the carcass 18. The beads 12 include bead wires 12A and bead fillers.

The sidewalls 14 connect the beads 12 and the tread 16 to each other.

The tread 16, which serve to contact the ground, has an outer circumferential surface 16 with grooves 16A defined therein that provide a tread pattern.

The carcass 18 extends in and along the inner surfaces of the sidewalls 14 and the tread 16 between the beads 12. The carcass 18 has its opposite ends folded back on themselves around the bead wires 12A and the bead fillers from the inner to outer sides of the beads 12. The carcass 18 extends fully in the circumferential directions of the tire 10, keeping the shape of the tire 10.

In the tread 16, the carcass 18 extends circumferentially in an inner portion of the tread 16.

As shown in FIGS. 2 and 3, the carcass 18 comprises a rubber web 18A and a plurality of parallel cords 18B embedded in the rubber web 18A at spaced intervals in the circumferential directions of the tire 10. The cords 18B extend transversely across the tire 10.

The rubber web 18A may be made of any of various known rubbers. The cords 18B may be made of any of various known steels or plastics.

The cords 18B may be spaced at equal intervals. Alternatively, the cords 18B may be spaced at different intervals which may be constant or may vary in their longitudinal direction. The cords 18B may be straight throughout their entire length or may be curved or tortuous partly or fully along their entire length.

The belt 20 is disposed in an inner portion of the tread 16 and extends in the circumferential directions of the tire 10.

Specifically, the belt 20 is disposed between the outer circumferential surface of the carcass 18 and the inner circumferential surface of the portion of the tread 16 which has the tread pattern. The belt 20 is tightly held against the carcass 18 radially inwardly of the tire 10, stiffening the tire 10 to prevent the tire 10 from being unduly expanded when it is inflated.

As shown in FIGS. 2 and 3, the belt 20 comprises a first belt member 22 disposed on the outer circumferential surface of the carcass 18 and a second belt member 24 disposed on the outer circumferential surface of the first belt member 22.

The first belt member 22 comprises a rubber web 22A and a plurality of parallel cords 22B embedded in the rubber web 22A and spaced from each other.

The second belt member 24 comprises a rubber web 24A and a plurality of parallel cords 24B embedded in the rubber web 24A and spaced from each other.

The rubber webs 22A, 24A may be made of any of various known rubbers. The cords 22B, 24B may be made of any of various known steels or plastics.

As shown in FIGS. 2 and 3, the cords 22B of the first belt member 22 extend obliquely across the cords 18B of the carcass 18, and the cords 24B of the second belt member 24 extend obliquely across both the cords 22B of the first belt member 22 and the cords 18B of the carcass 18, as viewed in the radial directions of the tire 10.

The cords 22B, 24B may be spaced at equal intervals. Alternatively, the cords 22B, 24B may be spaced at different intervals which may be constant or may vary in their longitudinal direction. The cords 22B, 24B may be straight throughout their entire length or may be curved or tortuous partly or fully along their entire length.

In the present embodiment, the rubber web 18A of the carcass 18 and the rubber webs 22A, 24A of the belt 20 are made of a polymer such as natural rubber or synthetic rubber and a filler such as carbon black or silica. Therefore, the rubber webs 18A, 22A, 24A are made of a viscoelastic material which is referred to as a compound.

The beads 12, the sidewalls 14, the tread 16, the carcass 18, and the first and second belt members 22, 24 are integrally joined together when their rubber materials are vulcanized.

As shown in FIG. 1, the inner surface of the tire 10, i.e., the inner circumferential surface of the carcass 18, is covered with an inner liner 26 of rubber which serves to prevent air from leaking out of the tire 10.

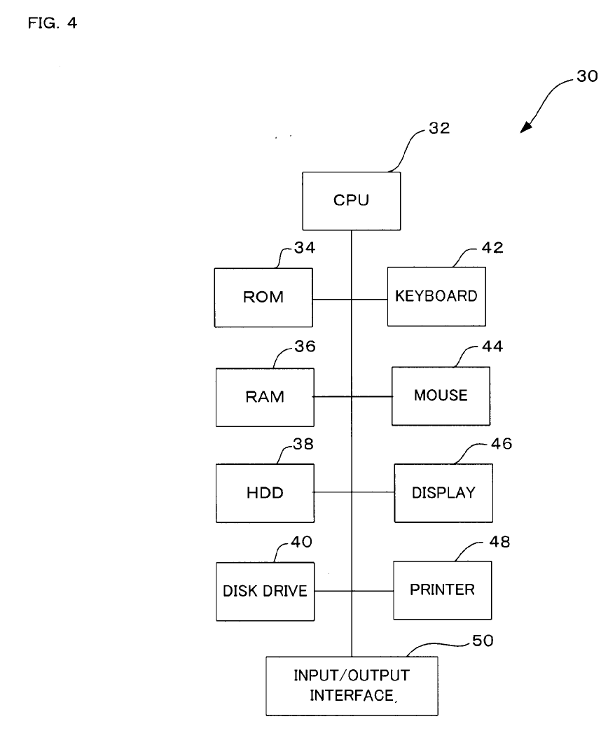

FIG. 4 shows in block form a computer 30 that is used for carrying out the method of simulating a pneumatic tire according to the embodiment of the present invention.

As shown in FIG. 4, the computer 30 comprises a CPU 32, a ROM 34, a RAM 36, a hard disk drive 38, a disk drive 40, a keyboard 42, a mouse 44, a display 46, a printer 48, and an input/output interface 50 which are interconnected by interface circuits, not shown, and bus lines.

The ROM 34 stores a control program, and the RAM 36 provides a memory space referred to as a working area.

The hard disk drive 38 stores programs for performing the method of simulating a pneumatic tire according to the embodiment of the present invention.

The disk drive 40 serves to record data in and/or read data from a recording medium such as a CD or a DVD.

The keyboard 42 and the mouse 44 serve to enter input signals from the operator into the computer 30.

The display 46 serves to display data. The printer 48 serves to print data. Therefore, the display 46 and the printer 48 serve to output data from the computer 30.

The input/output interface 50 sends data to and receives data from an external device that is connected to the computer 30.

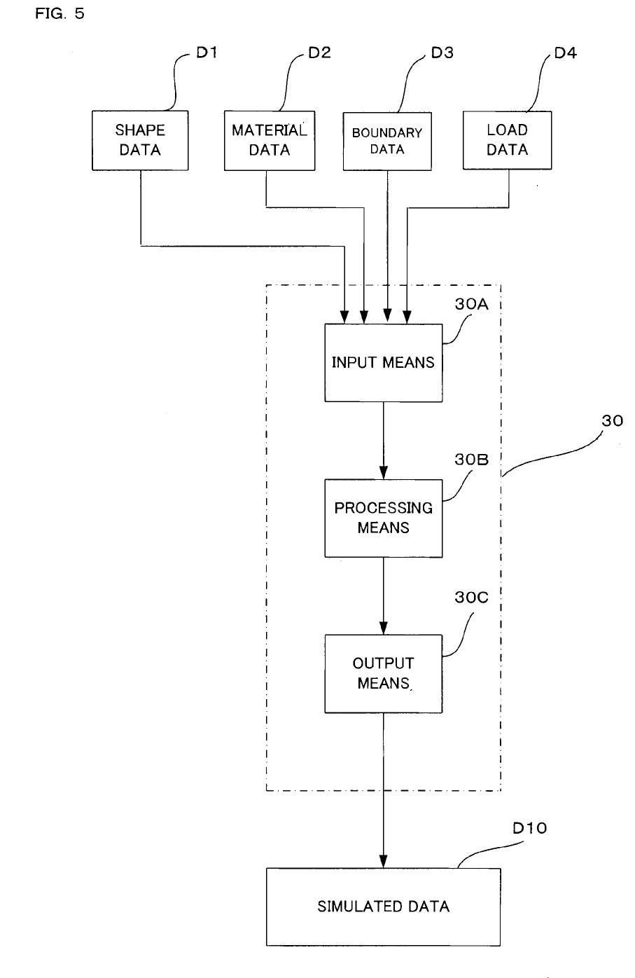

FIG. 5 shows in block form a functional system provided by the computer 30 shown in FIG. 4.

As shown in FIG. 5, the computer 30 functionally comprises an input means 30A, a processing means 30B, and an output means 30C.

As shown in FIGS. 4 and 5, the CPU 32, the keyboard 42, the mouse 44, the disk drive 40, and the input/output interface 50 jointly make up the input means 30A. The CPU 32 makes up the processing means 30B. The CPU 32, the display 46, the printer 48, the disk drive 40, and the input/output interface 50 jointly make up the output means 30C.

The input means 30A serves to enter data required to determine stresses or strains on the tire 10 including a composite assembly to be described below according to a finite element method. The data entered through the input means 30A will be described later.

The processing means 30B functions to produce stresses or strains on the tire 10 based on the data entered through the input means 30A according to the finite element method. The processing means 30B with such a function is implemented when a corresponding program stored in the hard disk drive 38 is loaded into the RAM 36 and run by the CPU 32.

The processing means 30B also functions to receive various data entered through the input means 30A for setting a finite element model. The processing means 30B with such a function is also implemented when a corresponding program stored in the hard disk drive 38 is loaded into the RAM 36 and run by the CPU 32.

The output means 30C serves to output data that are calculated by the processing means 30B.

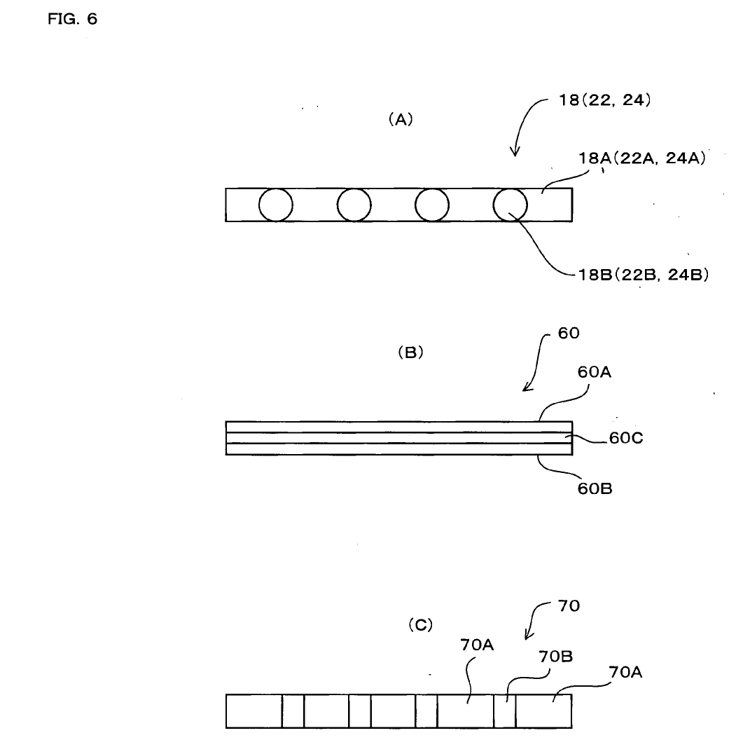

FIG. 6(A) is a schematic cross-sectional view of the composite assembly, FIG. 6(B) is a schematic cross-sectional view of a finite element model of the composite assembly according to the background art, and FIG. 6(C) is a schematic cross-sectional view of a finite element model of the composite assembly according to the embodiment of the present invention.

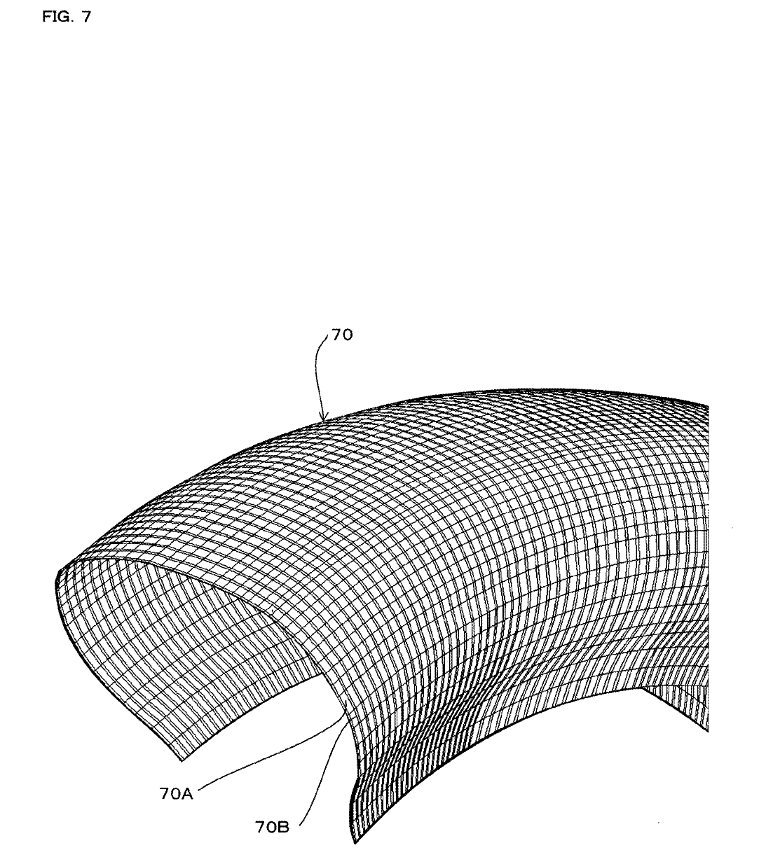

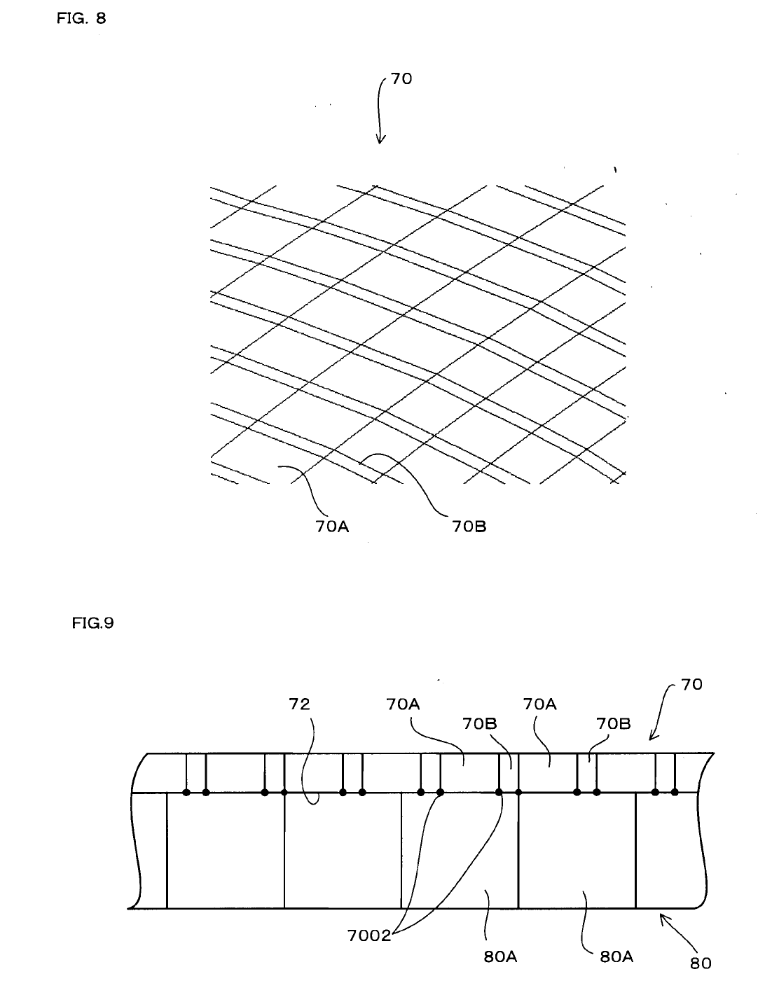

FIG. 7 is a partial perspective view of a finite element model of the carcass 18 of the composite assembly according to the embodiment of the present invention. FIG. 8 is an enlarged perspective view of a portion of the finite element model.

FIG. 9 is a schematic view showing the constraint of nodes of the finite element model of the composite assembly according to the embodiment of the present invention.

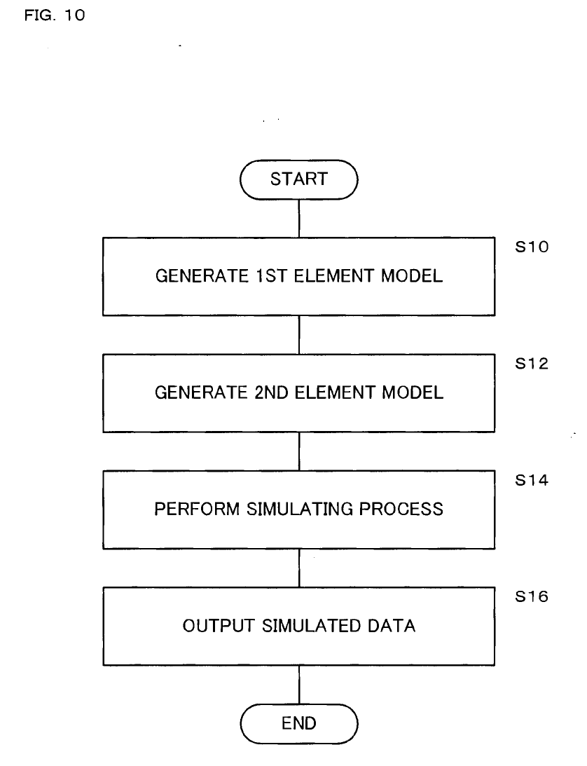

FIG. 10 is a flowchart of the sequence of the method of simulating a pneumatic tire according to the embodiment of the present invention.

The method of simulating a pneumatic tire according to the embodiment of the present invention will be described in detail below with reference to FIGS. 6(A) through 10.

First, the tire 10 is divided into a plurality of finite elements according to a finite element method, and finite element models are generated using the finite elements. Specifically, finite element models are generated respectively of a portion of the tire 10 which is exclusive of the composite assembly, i.e., the beads 12, the sidewalls 14, and the tread 16, and the composite assembly, i.e., the carcass 18 and the belt 20.

The portion of the tire 10 which is exclusive of the composite assembly is divided into a number of finite elements according to the finite element method, generating a first finite element model (step S10 in FIG. 10).

Specifically, step S10 is carried out as follows: The processing means 30B displays on the display 46 an input screen for prompting the operator to enter various data required to generate a finite element model. The operator enters the required data through the keyboard 42 and the mouse 44, and the processing means 30B receives the entered data.

The first finite element model of the portion of the tire 10 which is exclusive of the composite assembly may be any of various known solid element models.

Then, the composite assembly is divided into a number of finite elements according to the finite element method, generating a second finite element model (step S12 in FIG. 10).

Step S12 is carried out in the same manner as with step S10. Specifically, the processing means 30B displays on the display 46 an input screen for prompting the operator to enter various data required to generate a finite element model. The operator enters the required data through the keyboard 42 and the mouse 44, and the processing means 30B receives the entered data.

As shown in FIG. 6(A), the carcass 18 comprises a rubber web 18A and a plurality of parallel cords 18B embedded in the rubber web 18A.

Likewise, the first belt member 22 comprises a rubber web 22A and a plurality of parallel cords 22B embedded in the rubber web 22A, and the second belt member 24 comprises a rubber web 24A and a plurality of parallel cords 24B embedded in the rubber web 24A.

According to the background art, as shown in FIG. 6(B), for modeling the carcass 18 as an element model 60, the rubber web 18A is modeled into two quadrilateral membrane elements 60A, 60B, and the cord 18B is modeled into a quadrilateral membrane element 60C sandwiched between the quadrilateral membrane elements 60A, 60B, thus defining the anisotropy of the quadrilateral membrane element 60C.

According to the embodiment of the present invention, as shown in FIG. 6(C), the carcass 18 (the first and second belt members 22, 24) is modeled as a composite assembly element model 70 (second finite element model) by dividing the rubber web 18A (22A, 24A) into rubber web elements 70A as solid models, and dividing the cords 18B (22B, 24B) into cord elements 70B as solid elements.

Specifically, as shown in FIGS. 7 and 8, the composite assembly element model 70 of the carcass 18 is made up of the rubber web elements 70A and the cord elements 70B.

Each of the first and second belt members 22, 24 is modeled as a composite assembly element model 70 (second finite element model) by dividing the rubber web 22A, 24A into rubber web elements 70A as solid models, and dividing the cords 22B, 24B into cord elements 70B as solid elements.

Specifically, as shown in FIGS. 7 and 8, the composite assembly element model 70 of each of the first and second belt members 22, 24 is made up of the rubber web elements 70A and the cord elements 70B.

The belt 20 comprises a plurality of belt members, e.g., the first and second belt members 22, 24, and the belt members are arranged in at least two layers such that their cords extend across each other. In this case, each of the belt members or layers is individually modeled.

The cord elements 70B of the composite assembly element models 70 of the carcass 18 and the first and second belt members 22, 24 have a polygonal cross-sectional shape, i.e., at least a quadrangular cross-sectional shape, which remains constant throughout the full length of the cord elements 70B.

The number of cord elements 70B is smaller when their cross-sectional shape is polygonal than when it is circular. Accordingly, the computational efforts required to simulate the tire 10 are reduced.

Actually, the cords 18B, 22B, 24B have a substantially circular cross-sectional shape. If they are modeled as nearly circular cross-sectional shapes using a number of elements, then the modeling process requires a very long computational time which makes the modeling process practically infeasible.

In particular, each of the cords 22B, 24B of the belt 20 is often made of a plurality of twisted metal wires. If the cords 22B, 24B are modeled as nearly circular cross-sectional shapes, they need to be divided into many small elements. Therefore, the modeling process requires a very long computational time which makes the modeling process practically infeasible.

According to the embodiment of the present invention, cords having a circular cross-sectional shape or cords made up of a plurality of metal wires are modeled as a finite element model made up of finite elements having identical polygonal cross-sectional shapes, i.e., at least quadrangular cross-sectional shapes. The number of finite elements required is thus reduced, and the modeling process requires reduced computational efforts and a shortened computational time. The modeling process is highly advantageous in easily simulating motion of the cords while the tire 10 is rotating.

The polygonal cross-sectional shape of the cord elements 70B for the purpose of reducing the number of elements should preferably be a quadrangular cross-sectional shape, a hexagonal cross-sectional shape, or an octagonal cross-sectional shape.

As described above, the computational efforts for simulating the tire 10 can be reduced by reducing the number of elements with the polygonal cross-sectional shape of the cord elements 70B. However, since the carcass 18 or each of the first and second belt members 22, 24 of the single tire 10 has 1000 to 1500 cords, there is a certain limitation on attempts to reduce the computational efforts if the number of cord elements 70B is equal to the number of actual cords.

Consequently, it is more preferable to make the number of cord elements 70B smaller than the number of actual cords for reducing the computational efforts.

According to the embodiment of the present invention, the number of cord elements 70B per unit length in a direction perpendicular to the directions in which the cord elements 70B extend is made smaller than the number of cords 18, 22B, or 24B per unit length in a direction perpendicular to the directions in which the cords 18, 22B, or 24B extend, thereby reducing the computational efforts.

In a specific example, actual 1500 cords are modeled as 500 cord elements 70B. If the number of cord elements 70B is reduced too much, then the accuracy of the simulation is unduly lowered. For keeping the desired simulation accuracy while reducing the computational efforts, it is preferable to reduce the number of cord elements 70B to about one-fifth of the actual number of cords.

If the product of the number of cord elements 70B per unit length in the direction perpendicular to the directions in which the cord elements 70B extend and the cross-sectional area of the cord elements 70B is equal to the product of the number of cords 18B, 22B, or 24B per unit length in the direction perpendicular to the directions in which the cords 18B, 22B, or 24B extend and the cross-sectional area of the cords 18B, 22B, or 24B, then the number of cord elements 70B is reduced and hence the computational efforts are reduced while modeling the cords 18B, 22B, or 24B without sacrificing the simulation accuracy.

Alternatively, the product of the number of cord elements 70B per unit length in the direction perpendicular to the directions in which the cord elements 70B extend, the cross-sectional area of the cord elements 70B, and the modulus of the cord elements 70B may be equal to the product of the number of cords 18B, 22B, or 24B per unit length in the direction perpendicular to the directions in which the cords 18B, 22B, or 24B extend, the cross-sectional area of the cords 18B, 22B, or 24B, and the modulus of the cords 18B, 22B, or 24B.

Since the modulus of the cords 18B, 22B, or 24B is reflected in generating the cord elements 70B, the above alternative is more effective to reduce the number of cord elements 70B and hence the computational efforts while modeling the cords 18B, 22B, or 24B to keep the simulation accuracy at a higher level.

As shown in FIG. 9, the composite assembly element model 70 and a tire portion element model 80 (first finite element model generated in step S10 shown in FIG. 10), which is generated from the portion of the tire 10 which is exclusive of the composite assembly, are joined to each other by an interfacial boundary 72. The tire portion element model 80 is made up of a plurality of finite elements 80A. The finite elements 80A of the tire portion element model 80 which faces the interfacial boundary are greater in size than the rubber web elements 70A and the cord elements 70B of the composite assembly element model 70 which faces the interfacial boundary 72.

This is because since the portion of the tire 10 which is exclusive of the composite assembly is relatively simple in structure, the number of the finite elements 80A per unit area of the interfacial boundary 72 may be smaller than the number of the rubber web elements 70A and the cord elements 70B per unit area of the interfacial boundary 72.

Usually, the diameter of the cords of the composite assembly is different from the distance between adjacent ones of the cords of the composite assembly. Therefore, the rubber web elements 70A and the cord elements 70B are different in size from each other.

Since the rubber web elements 70A, the cord elements 70B, and the finite elements 80A are different in size from each other, some nodes of the composite assembly element model 70 on the interfacial boundary and some nodes of the tire portion element model 80 on the interfacial boundary are not in conformity with each other.

According to the embodiment of the present invention, when the composite assembly element model 70 is generated, the number of the rubber web elements 70A and the cord elements 70B per unit area of the interfacial boundary 72 is greater than the number of the finite elements 80A per unit area of the interfacial boundary 72, and nodes 7002 of the composite assembly element model 70 on the interfacial boundary are constrained within the plane of the tire portion element model 80. Stated otherwise, a boundary condition is established for the element models 70, 80 whose finite elements have different sizes such that the nodes 7002 of the composite assembly element model 70 on the interfacial boundary are constrained within the plane of the tire portion element model 80 according to boundary conditions.

The above boundary condition allows the tire 10 including the composite assembly to be modeled more faithfully for more accurate simulation than simply when some nodes of the composite assembly element model 70 on the interfacial boundary and some nodes of the tire portion element model 80 on the interfacial boundary are not in conformity with each other.

In the illustrated embodiment, the composite assembly element model 70 corresponds to the carcass 18, and the tire portion element model 80 to an element model of the beads 12 and the sidewalls 14 lined with the carcass 18. The composite assembly element model 70 also corresponds to the belt 20, and the tire portion element model 80 to an element model of the tread 16 lined with the belt 20.

Then, the processing means 30B performs a simulating process for determining, by way of a finite element analysis, stresses which the tire 10 receives from the ground while running thereon and strains which the tire 10 undergoes due to the stresses, based on an analytic data that are entered through the input means 30A (step S14 in FIG. 10).

Specifically, as shown in FIG. 5, the operator enters shape data D1 of the composite assembly element model 70 and the tire portion element model 80, material data D2, boundary data D3, and load data D4 as the an analytic data through the input means 30A. The processing means 30B converts the analytic data into stresses and strains at local coordinates, thereby determining stresses and strains at one point of the composite assembly element model 70 and the tire portion element model 80.

The processing means 30B successively determines stresses and strains at all points of the composite assembly element model 70 and the tire portion element model 80 until the entire tire 10 is covered, and generates data of the determined stresses and strains.

According to the above simulating process, the tire 10 is dynamically simulated on the assumption that the tire 10 is running at a certain speed. Though the running speed of the tire 10 is optional, the tire 10 is dynamically simulated more effectively if it is assumed that the tire 10 is running at a speed of 60 km/h or higher.

The tire 10 may be statically simulated on the assumption that the tire 10 is held at rest. However, since the static simulation produces simulated data that are not greatly different from simulated data produced by the background art, the dynamic simulation according to the embodiment of the present invention is more effective to analyze the performance of the tire 10 accurately.

The processing means 30B supplies the generated data to the output means 30C. The output means 30C outputs the data as simulated data D10 (step S16 in FIG. 10).

The simulated data D10 are not limited to the stresses and strains of the tire 10, but may include heat data, for example, and may also include various known evaluative data for evaluating the durability and performance of the tire 10.

According to the embodiment of the present invention, as described above, a composite assembly of a pneumatic tire comprising a rubber web, such as the carcass 18 or the belt 20, and a plurality of cords embedded in the rubber web at spaced intervals is modeled as a composite assembly element model 70 by dividing the rubber web into rubber web elements 70A as solid models, and dividing the cords into cord elements 70B as solid elements. Consequently, stresses and strains of the composite assembly can accurately be analyzed, and the performance of the pneumatic tire 10 can accurately be evaluated.

For accurately judging the durability of the tire 10, it is necessary to determine shearing forces of the rubber web between the cords and to faithfully express flexing of the cords.

According to the embodiment of the present invention, since both the rubber web elements 70A and the cord elements 70B are modeled as solid elements, the deformation of the rubber web between the cords, the shearing forces of the rubber web between the cords, and the flexing of the cords can faithfully be analyzed, and the effects that they have on deformation, stresses, and strains of the tire 10 can be predicted with high accuracy.

The rubber webs 22A, 24A and the cords 22B, 24B of the belt 20 are separately modeled as the rubber web elements 70A and the cord elements 70B. The rubber web elements 70A and the cord elements 70B which are separate from each other make it possible to analyze the propagation of a belt edge separation which has heretofore been difficult to grasp according to an analyzing process of the background art. It is also made possible to analyze which path the belt edge separation tends to follow in an initial phase thereof. Consequently, the belt edge separation can be analyzed in detail.

The term “belt edge separation” refers to cracking in the rubber webs at the ends of the cords in the belt members or layers. Specifically, since the ends of the cords are not constrained, the ends of the cords tend to be greatly deformed while the tire is rotating, causing the rubber webs to crack due to shearing forces generated between the belt layers.

According to the embodiment of the present invention, furthermore, the rubber webs 22A, 24A and the cords 22B, 24B of each of the first and second belt members 22, 24 are separately modeled as the rubber web elements 70A and the cord elements 70B. Therefore, it is possible to analyze the propagation of a belt edge separation between the first and second belt members 22, 24, i.e., the belt layers.

The propagation of a belt edge separation between the belt layers leads to the growth of a crack produced in edges of the belt members due to a stress concentration on the crack. Particularly, a crack between the belt layers tends to spread because the cords in the belt layers are inclined at different angles and hence large shearing forces tend to be applied between the belt layers.

According to the embodiment of the present invention, moreover, the number of cord elements 70B per unit length in a direction perpendicular to the directions in which the cord elements 70B extend is smaller than the number of cords 18, 22B, or 24B per unit length in a direction perpendicular to the directions in which the cords 18, 22B, or 24B extend. As the number of divided finite elements of the composite assembly element model 70 is reduced, the computational efforts required to simulate the tire 10 are reduced, allowing the performance of the tire 10 to be evaluated with accuracy.

Simulated data obtained by simulating methods according to comparative and inventive examples will be described below.

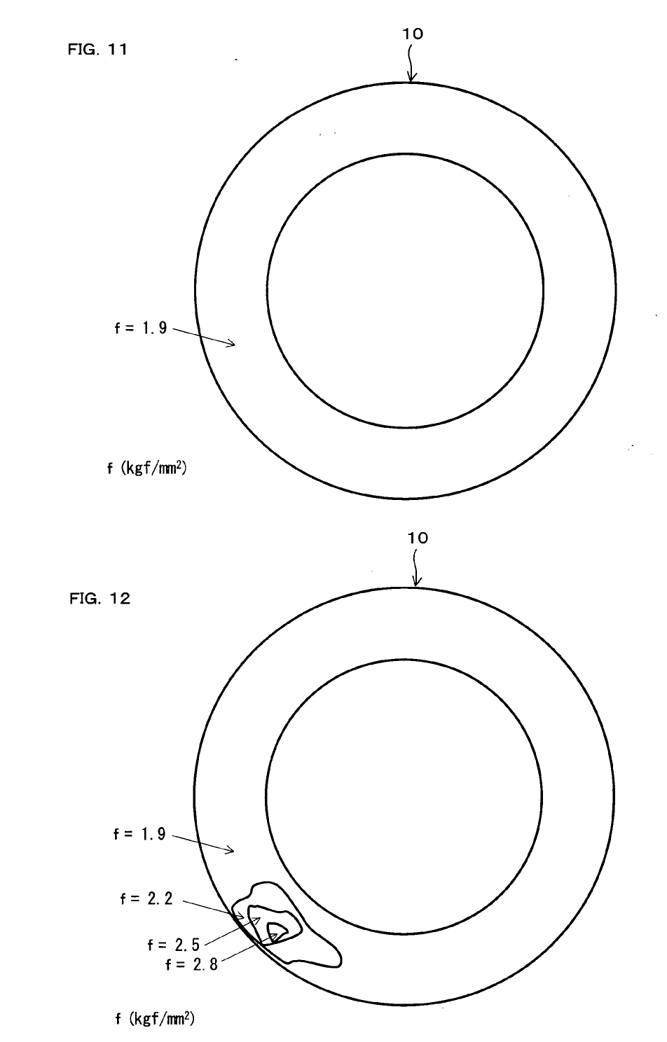

FIG. 11 is a view showing a distribution of stresses (strains) on a pneumatic tire 10 simulated by a simulating method according to a comparative example, and FIG. 12 is a view showing a distribution of stresses (strains) on a pneumatic tire 10 simulated by a simulating method according to an inventive example.

The simulating method according to the comparative example is a method according to the background art. In the simulating method according to the comparative example, a carcass was modeled as a quadrilateral membrane element with defined anisotropy, and the inclination of the carcass was defined by the angle of an anisotropic material.

In the simulating methods, the tires 10 were simulated under centrifugal forces corresponding to a running speed of 200 km/h.

FIGS. 11 and 12 show a simulated distribution of stresses (strains) f (kgf/mm²) of the tires 10 when the angle of carcass cords positioned at 7 to 8 o'clock indicated by a clock's short hand as viewed in plan was different from the angle of other carcass cords.

Specifically, the angle of carcass cords positioned at 7:30 o'clock indicated by the clock's short hand was 88 degrees with respect to the circumferential direction of the tire, and the angle of other carcass cords was 90 degrees with respect to the circumferential direction of the tire, i.e., the other carcass cords extended radially of the tire.

In the simulating method according to the comparative example, as shown in FIG. 11, the strains f are indicated as being distributed substantially uniformly in the circumferential direction of the tire 10.

In the simulating method according to the inventive example, as shown in FIG. 12, the stresses f are indicated as being distributed differently at the different angles of carcass cords. The simulating method according to the inventive example is thus capable of an analyzing the strains and stresses of the carcass (composite assembly) and evaluating the performance of the tire 10 more accurately than the simulating method according to the comparative example.

In the illustrated embodiment of the present invention, the carcass 18 is of a single-layer structure, and the cords 18B of the carcass 18 extends radially of the tire 10. The belt 20 is of a double-layer structure comprising the first and second belt members 22, 24, and the cords 22B, 24B of the first and second belt members 22, 24 extend across each other.

However, the simulating method according to the present invention is also applicable to different pneumatic tires having various composite assemblies (stiffeners), i.e., various structural details of the carcass 18 and the belt 20.

Although a certain preferred embodiment of the present invention has been shown and described in detail, it should be understood that various changes and modifications may be made therein without departing from the scope of the appended claims.

What is claimed is:

1. A method of simulating a pneumatic tire including a composite assembly comprising a rubber web and a plurality of parallel cords embedded in the rubber web at spaced intervals in the circumferential directions of the pneumatic tire, by approximating the pneumatic tire with a finite element model generated by dividing the pneumatic tire into a plurality of finite elements and analyzing the finite element model according to a finite element process, said method comprising the step of:
generating a composite assembly element model for the composite assembly by dividing the rubber web into rubber web elements as solid models and dividing the cords into cord elements as solid elements, according to the finite element process.

2. A method according to claim 1, wherein each of said cord elements has a uniform polygonal cross-sectional shape in a direction in which said each of the cord elements extends.

3. A method according to claim 1, wherein the number of cord elements per unit length in a direction perpendicular to the directions in which the cord elements extend is smaller than the number of cords per unit length in a direction perpendicular to the directions in which the cords extend.

4. A method according to claim 1, wherein the product of the number of cord elements per unit length in a direction perpendicular to the directions in which the cord elements extend and the cross-sectional area of the cord elements is equal to the number of cords per unit length in a direction perpendicular to the directions in which the cords extend and the cross-sectional area of the cords.

5. A method according to claim 1, wherein the product of the number of cord elements per unit length in a direction perpendicular to the directions in which the cord elements extend, the cross-sectional area of the cord elements, and the modulus of the cord elements is equal to the number of cords per unit length in the direction perpendicular to the directions in which the cords extend, the cross-sectional area of the cords, and the modulus of the cords.

6. A method according to claim 1, wherein said pneumatic tire includes another tire portion held in contact with said composite assembly, said other tire portion being modeled as a tire portion element model by dividing the other tire portion into a plurality of finite elements by the finite element process, said composite assembly element model and said tire portion element model being joined to each other by an interfacial boundary;
wherein the number of rubber web elements and cord elements per unit area of the interfacial boundary is greater than the number of finite elements of the tire portion element model per unit area of the interfacial boundary, and nodes of the composite assembly element model on the interfacial boundary are constrained within a plane of the tire portion element model.

7. A method according to claim 1, wherein said composite assembly comprises a belt of the pneumatic tire.

8. A method according to claim 1, wherein said composite assembly comprises a carcass of the pneumatic tire.
